(19) United States
(12) Patent Application Publication
(10) Pub. No.: US 2025/0263550 A1
(43) Pub. Date: Aug. 21, 2025

(54) MINERAL-FILLED POLYCARBONATE BLEND MOULDING COMPOSITION HAVING A LOW BPA CONTENT, AND METHOD FOR PREPARING SAME

(71) Applicant: Covestro Deutschland AG, Leverkusen (DE)

(72) Inventors: Andreas Seidel, Dormagen (DE); Jan Wintermeyer, Wesel (DE); Marius Nolte, Köln (DE); Eckhard Wenz, Köln (DE); Hans-Juergen Thiem, Dormagen (DE)

(21) Appl. No.: 18/997,615

(22) PCT Filed: Jul. 21, 2023
(86) PCT No.: PCT/EP2023/070255

§ 371 Date: Jan. 22, 2025

(30) Foreign Application Priority Data
Jul. 28, 2022 (EP) 22187468.8

(51) Int. Cl. C08L 69/00; B29B 7/06; B29B 7/82; B29K 25/00; B29K 67/00; B29K 69/00; B29K 96/02; C08K 3/34

(52) U.S. Cl. CPC C08L 69/00; B29B 7/06; B29B 7/82; C08K 3/34; B29K 2025/08; B29K 2067/003; B29K 2069/00; B29K 2096/02; B29K 2995/0037; C08L 2205/035

(57) ABSTRACT

The invention relates to a thermoplastic moulding composition containing: A) at least one polycarbonate and/or polyester carbonate each containing structural units derived from bisphenol-A; B) a further polymer different from component A or a mixture consisting of polymers each different from component A, wherein Component B consists of B1) at least one thermoplastic polymer and optionally B2) at least one non-thermoplastic polymer; C) at least one inorganic filler selected from the group consisting of quartz compounds, talc, wollastonite, kaolin, CaCO₃, titanium dioxide, and titanium dioxide in combination with other inorganic pigments, Al(OH)₃. AlO(OH), Mg(OH)₂ and mica as well as combinations of said fillers; and D) optionally at least one non-polymeric polymer additive and/or at least one non-polymeric processing aid, in each case different from component C, wherein the weight ratio of component B to component C is at least 0.5 and wherein the weight proportion of component B1 in component B is at least 20%, and wherein the moulding composition has a mass fraction of free bisphenol-A of less than 30 ppm. The invention also relates to: a method for producing a moulding composition; the use of the moulding composition to produce a moulded body; and a moulded body containing the moulding composition or consisting of the moulding composition.

The invention relates to a mineral-filled polycarbonate blend molding compound, to a process for producing a mineral-filled polycarbonate blend molding compound, to the use of the molding compound for producing a shaped article and to a shaped article containing the molding compound.

Polycarbonate blend molding compounds have long been known. The molding compounds are used to produce shaped articles for a multiplicity of applications, for example for the automotive sector, for the construction sector and for the electronics sector. In most cases the polycarbonates employed are polycarbonates containing structural units derived from bisphenol A. In the context of the present invention “containing structural units derived from bisphenol A” is to be understood as meaning that bisphenol A is used as the diphenol component in the production of the polycarbonate, optionally together with other diphenols. The bisphenol A is thus covalently incorporated in the polymer chain via carbonate groups which are generally formed in the production of the polycarbonate by a polycondensation reaction of the hydroxy groups in the bisphenol A with acid halide or ester groups of a carbonyl halide or carboxylic ester.

The properties of the shaped articles produced from such thermoplastic molding compounds can be adapted to the requirements of the respective use via the selection of the components of the compositions and the quantity ranges in which these components are employed in the compositions. To increase toughness, especially at low temperatures, blend partners having elastomeric properties are added to the polycarbonate as impact modifiers.

Especially in the field of application of automotive body components and in two-component components consisting of an opaque frame and a transparent or translucent window, efforts are increasingly being made to substitute metal for plastic with the aim of reducing vehicle weight and thus fuel consumption, because of the simple producibility of automotive plastic components by injection molding and because of the greater design freedom and opportunity for function integration.

For large surface area horizontal automotive body components it is demanded inter alia that the molded bodies have a low coefficient of thermal expansion for high dimensional stability and low warpage to realize small panel gaps as well as a high material stiffness (high modulus of elasticity). To meet such a profile of requirements in many cases mineral fillers such as for example talc are employed as a constituent of the polycarbonate blend molding compound. It is also possible to employ inorganic pigments such as titanium dioxide to color the molding compounds.

EP 0 391 413 A2 discloses polymer compositions containing 40% to 80% by weight of aromatic polycarbonate, 5% to 50% by weight of rubber-modified homopolymer or copolymer of a vinylaromatic monomer, for example ABS, and 4% to 18% by weight of a flaked inorganic filler, for example talc, which feature a reduced coefficient of thermal expansion, good low-temperature ductility and high heat resistance.

EP 0 452 788 A2 discloses molded parts produced from talc-filled PC/ABS compositions which feature a combination of good mechanical properties and reduced gloss. The compositions contain to 80 parts by weight of polycarbonate, 20 to 90 parts by weight of ABS and 2 to 25 parts by weight, based on a total of 100 parts by weight of polycarbonate and ABS, of talc having a median particle size of 1.5 to 20 μm. The molding compounds are produced from these compositions by a single-step compounding process.

WO 98/51737 A1 discloses thermoplastic polymer compositions having improved properties, for example, in terms of heat resistance, melt flowability, low temperature impact strength and dimensional stability, containing 65% to 85% by weight of aromatic polycarbonate, 10% to 50% by weight of a rubber-modified copolymer, for example ABS, and 1% to 15% by weight of a particulate mineral filler, for example talc, having an average largest characteristic dimension of 0.1 to 30 μm. This application too exclusively discloses production of the thermoplastic molding compounds by means of a single-step compounding process.

However, the use of inorganic fillers such as talc or titanium dioxide in the polycarbonate blend molding compounds can lead to an increased sensitivity to thermal stress since for example basic constituents of the filler initiate degradation of the polycarbonate molecular weight. To avoid such an effect which can ultimately have an adverse effect on mechanical properties and component surface quality, stabilization of the molding compounds is advantageous. Compounds suitable therefor include for example Brønsted-acidic compounds which are added to the molding compounds during compounding.

WO 2013/060687 A1 discloses polycarbonate compositions stabilized with a Brønsted-acidic compound having improved thermal processing stability containing optionally rubber-modified vinyl (co)polymer and also optionally talc which are produced in a special process in which the Brønsted-acidic compound is taken up on an inorganic or organic adsorber/absorber, preferably on a finely-divided silica, before compounding. The disclosed heat-stabilized polycarbonate compositions are produced in a single-step compounding process. Mechanical powder mixtures of pulverulent formulation components may be employed.

Polycarbonate molding compounds and the shaped articles produced therefrom generally contain small amounts of free, i.e. not chemically bonded, bisphenol A (BPA). However, efforts are being made to effect strict regulatory limitation of these contents of free BPA in the molding compounds and articles with the aim of minimizing the environmental impact of BPA. Preparations are being made in the corresponding bodies of the European Union for example.

It has been found that inorganic fillers as constituents of the polycarbonate molding compound can contribute to an increase in the content of free BPA, in particular at high processing temperatures and long residence times in the melt, and that the production and processing of such molding compounds requires particular care also from this standpoint.

Inorganic fillers can further lead to a deterioration in the mechanical data of the shaped articles produced from the polycarbonate molding compounds. Especially the toughness under multiaxial stress, as tested for example in a penetration test, may be adversely affected.

It was accordingly desirable to provide a mineral-filled polycarbonate blend molding compound having improved multiaxial toughness. The maximum force and energy should preferably be enhanced to reduce the number of samples exhibiting shatter fracture failure (brittle fracture). The latter is of great importance for use in safety-relevant applications in the automotive sector for instance.

It was further desirable to provide a process for producing a mineral-filled polycarbonate blend molding compound having a reduced content of BPA.

WO 2008/122359 A1 discloses talc-filled PC/ABS compositions and molding compounds produced therefrom which are stabilized against polycarbonate degradation through addition of Brønsted acids and exhibit improved thermal stability during compounding and shaping. This application is silent about the effect of the Brønsted acids on the content of free BPA in such molding compounds and molded parts produced therefrom.

WO 99/28386 A1 discloses molded compounds containing at least one aromatic or semiaromatic polyester and at least one polycarbonate, at least one graft copolymer, at least one copolymer containing vinylaromatic monomers, at least one filler and at least one low molecular weight halogen-free acid. Further disclosed optional components in these molding compounds include polyacrylate, flame retardants and polymer additives. The molding compounds are characterized by improved mechanical properties (elongation at break) and improved melt flowability. The molding compounds are preferably produced by mixing all components at temperatures of 200° C. to 320° C. by co-extrusion, i.e. in a single-step compounding process. This application further discloses that individual components may be premixed. However, the application is silent about technical effects that are achievable with such a premixing of individual components as well as about which components of the composition are advantageously premixed and about the manner and conditions in which this premixing is effected.

WO 2018/037037 A1 discloses compositions obtained by mixing at least components A) to C), wherein A) is polycarbonate, B) is unsized talc and C) is at least one anhydride-modified alpha-olefin polymer having an acid number of at least 30 mg KOH/g and an average molecular weight Mw of 4000 to 40 000 g/mol, wherein before mixing the amounts of B) and C) are matched to one another such that per 10 parts by weight of component B)_{0.10} to 1.4 parts by weight of component C) are employed and wherein the composition is free from polyesters and graft polymers. In these compositions the polycarbonate exhibits improved stability against decomposition. In the production of the compositions the talc B) is subjected to sizing with the anhydride-modified alpha-olefin polymer C) in situ during the mixing of the talc B) with polycarbonate A) in the melt, i.e. during the mixing of talc B) and alpha-olefin polymer C) the polycarbonate A) is at least partially, but in a preferred embodiment already completely, present in the melt.

US 2006/0287422 A1 discloses thermoplastic polycarbonate compositions containing a mineral filler and a preferably inorganic acid or an acidic salt of a preferably inorganic acid and optionally an impact modifier and/or a vinyl (co)polymer, wherein the filler and the acid or acidic salt are employed in a specific ratio. Molding compounds consisting of such compositions exhibit improved mechanical properties and improved thermal stability of the polycarbonate towards molecular weight degradation. The examples disclosed in the application were all produced in a single-step compounding process in a twin-screw extruder which is apparently regarded as preferred.

The described prior art does not yet provide a sufficient solution to the aforementioned problems.

However, it has now been found that at least one of the aforementioned problems is solved by a molding compound containing
A) at least one polycarbonate and/or polyester carbonate in each case containing structural units derived from bisphenol A,
B) a further polymer distinct from component A or a mixture consisting of polymers in each case distinct from component A,
wherein component B consists of
B1) at least one thermoplastic polymer and
optionally B2) at least one non-thermoplastic polymer,
C) at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and combinations of the recited fillers, wherein component C preferably contains talc,
D) optionally at least one non-polymeric polymer additive and/or at least one non-polymeric process auxiliary, in each case distinct from component C,
wherein the weight ratio of component B to component C is at least 0.5, preferably at least 1 and particularly preferably at least 1.3
and wherein the weight fraction of component B1 in component B is at least 20%, preferably at least 50%, more preferably at least 70% by weight,
and wherein the molding compound has a mass fraction of free bisphenol A of less than 30 ppm, preferably of less than 20 ppm and particularly preferably of less than 10 ppm.

The polycarbonates and polyester carbonates employed as component A in the context of the present invention are synonymously also referred to hereinafter as aromatic polycarbonates or aromatic polyester carbonates.

Component B is preferably selected from the group consisting of rubber-free vinyl (co)polymers, rubber-modified vinyl (co)polymers, aromatic polyesters and mixtures of in each case one or more of such polymers, particularly preferably selected from the group consisting of rubber-free vinyl (co)polymers and rubber-modified vinyl (co)polymers and mixtures of in each case one or more of such polymers.

The molding compound preferably contains
30% to 85% by weight, more preferably 40% to 80% by weight and particularly preferably 45% to 75% by weight of component A,
2% to 50% by weight, more preferably 7% to 40% by weight and particularly preferably 15% to 35% by weight of component B,
3% to 40% by weight, more preferably 5% to 30% by weight and particularly preferably 8% to 25% by weight of component C,
0% to 10% by weight, more preferably 0.1% to 5% by weight and particularly preferably 0.2% to 3% by weight of component D.

These recited % by weight are based on the total weight of the thermoplastic molding compound.

The weight ratio of component B to component C is preferably 0.5 to 5, preferably 1 to 3 and particularly preferably 1.3 to 2.

In a further preferred embodiment the molding compound consists to an extent of at least 90% by weight, more preferably to an extent of at least 95% by weight and most preferably to an extent of 100% by weight of the components A, B, C and D.

It has likewise been found that a molding compound having the desired properties is obtained by a process for producing a thermoplastic molding compound comprising the steps of:
(i) producing a masterbatch by melt compounding the following components in an internal kneader or a co-kneader:
   B) a polymer distinct from polycarbonate containing structural units derived from bisphenol A and distinct from polyester carbonate containing structural units derived from bisphenol A or a mixture consisting of polymers distinct from polycarbonate containing structural units derived from bisphenol A and distinct from polyester carbonate containing structural units derived from bisphenol A,
   wherein component B consists of
   B1) at least one thermoplastic polymer and optionally B2) at least one non-thermoplastic polymer,
   C) at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and combinations of the recited fillers, wherein component C preferably contains talc, and
   D) optionally at least one non-polymeric polymer additive and/or at least one non-polymeric process auxiliary, in each case distinct from component C,
   wherein the weight ratio of component B to component C is at least 0.5, preferably at least 1 and particularly preferably at least 1.3
   and
   wherein the weight fraction of component B1 in component B is at least 50%, preferably at least 60%, more preferably at least 70% by weight,
   and
(ii) melt compounding of the masterbatch obtained in step (i) with at least one polycarbonate and/or polyester carbonate containing structural units derived from bisphenol A as component A and optionally further proportions of components B, C and/or D and/or the total amount of component D.

The weight ratio of component B to component C in the process according to the invention is preferably 0.5 to 5, more preferably 1 to 3 and particularly preferably 1.3 to 2.

Component B is preferably selected from the group consisting of rubber-free vinyl (co)polymers, rubber-modified vinyl (co)polymers, aromatic polyesters and mixtures of in each case one or more of such polymers, particularly preferably selected from the group consisting of rubber-free vinyl (co)polymers, rubber-modified vinyl (co)polymers and mixtures of in each case one or more of such polymers.

In the process according to the invention it is also possible to employ only a sub-amount of the altogether employed amount of component B and/or of component C and/or of component D in step (i). In this case the residual amount of component B and/or of component C and/or of component D is employed in step (ii). It is also possible to employ the total amount of component D in step (ii).

It is preferable to employ at least 80% by weight, more preferably at least 90% by weight, particularly preferably at least 95% by weight, of the total amount of component C in step (i). It is most preferable to employ the total amount of component C in step (i).

Step (ii) is preferably performed in a compounding apparatus selected from the group consisting of single-screw extruders, co-rotating or counter-rotating twin-screw extruders, planetary roller extruders, internal kneaders or co-kneaders. A co-kneader is a continuously operated kneader. Internal kneaders are generally operated in batch mode, i.e. discontinuously.

The co-kneader is preferably operated such that it simultaneously effects rotation and axial back and forth movement of the mixing and kneading screw shaft. The oscillating screw shaft ensures intensive product exchange in the axial direction.

Steps (i) and (ii) are performed in a temperature range of 200° C. to 350° C. with a residence time of the components in the melt in the range from 15 seconds to 5 minutes.

Process step (i) is particularly preferably carried out in a co-kneader. When process step (i) is carried out in a co-kneader step (i) is preferably performed at a temperature of the melt in the range from 210° C. to 260° C., more preferably in the range from 215° C. to 250° C., particularly preferably in the range from 220° C. to 240° C. When process step (i) is performed in a co-kneader, the residence time of the components in the melt in step (i) is preferably in the range from 1 to 5 minutes, more preferably in the range 1.5 to 4 minutes, particularly preferably in the range from 2 to 3.5 minutes.

It is particularly preferable when process step (ii) is performed in a twin-screw extruder. When process step (ii) is performed in a twin-screw extruder, step (ii) is preferably performed at a temperature of the melt in the range from 260° C. to 320° C. When process step (ii) is performed in a twin-screw extruder the residence time of the components in the melt in step (ii) is preferably in the range from 15 to 60 seconds.

In a particularly preferred process, step (i) is performed in a co-kneader at a temperature of the melt in the range from 210° C. to 260° C. and with a residence time of the components in the melt in the range from 1 to 5 minutes and step (ii) is performed in a twin-screw extruder at a temperature of the melt in the range from 260° C. to 320° C. and with a residence time of the components in the melt in the range from 15 to 60 seconds.

It is also possible to carry out a degassing of the present composition by application of negative pressure either in step (i) or in step (ii). The absolute pressure established is preferably not more than 400 mbar, more preferably not more than 300 mbar, particularly preferably not more than 200 mbar. The degassing is preferably carried out in step (ii).

The preferred ranges for the proportions of components A, B, C and D recited for the molding compound also apply for the process according to the invention. The proportions then refer to the altogether employed amounts, irrespective of whether sub-amounts or the total amounts of components B and D are employed in step (i).

### Component A

Polycarbonates and/or polyester carbonates according to component A that are suitable according to the invention are known from the literature or can be produced by processes known from the literature (for the production of polycarbonates see for example Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610, DE-A 3 832 396; for the production of polyester carbonates, for example DE-A 3 007 934).

The production of polycarbonates suitable according to the invention for use as component A is carried out for example by reaction of bisphenol A and optionally further diphenols with carbonyl halides, preferably phosgene, and/or with aromatic dicarbonyl dihalides, preferably dihalides of benzenedicarboxylic acid, by the interfacial process, optionally using chain terminators, for example monophenols, and optionally using trifunctional or more than trifunctional branching agents, for example triphenols or tetraphenols. Production via a melt polymerization process by reaction of bisphenol A and optionally further diphenols with diphenyl carbonate for example is likewise possible.

Diphenols other than bisphenol A which are suitable for producing the polycarbonates suitable according to the invention as component A and/or for producing the polyester carbonates suitable according to the invention as component A preferably include those of formula (I)

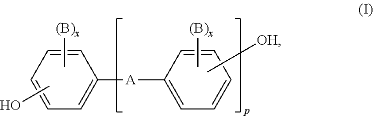

wherein
A is a single bond, C₁ to C₅ alkylene, C₂ to C₅ alkylidene, C₅ to C₆ cycloalkylidene, —O—, —SO—, —CO—, —S—, —SO₂—, C₆ to C₁₂ arylene, onto which further aromatic rings optionally containing heteroatoms may be fused,
   or a radical of formula (II) or (III)

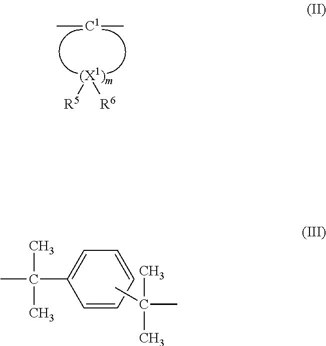

B is in each case C₁ to C₁₂ alkyl, preferably methyl, halogen, preferably chlorine and/or bromine,
x is in each case independently 0, 1 or 2,
p is 1 or 0, and
R⁵ and R⁶ are individually selectable for each X¹ and independently of one another hydrogen or C₁ to C₆ alkyl, preferably hydrogen, methyl or ethyl,
X¹ is carbon and
m is an integer from 4 to 7, preferably 4 or 5, with the proviso that, on at least one atom X¹, R⁵ and R⁶ are both alkyl.

Preferred diphenols other than bisphenol A employed include hydroquinone, resorcinol, dihydroxydiphenols, bis(hydroxyphenyl) C₁-C₅ alkanes, bis(hydroxyphenyl) C₅-C₆ cycloalkanes, bis(hydroxyphenyl) ethers, bis(hydroxyphenyl) sulfoxides, bis(hydroxyphenyl) ketones, bis(hydroxyphenyl) sulfones and α, α-bis(hydroxyphenyl)diisopropylbenzenes and also ring-brominated and/or ring-chlorinated derivatives thereof.

Particularly preferred further diphenols are 4,4′-dihydroxybiphenyl, 2,4-bis(4-hydroxyphenyl)-2-methylbutane, 1,1-bis(4-hydroxyphenyl)cyclohexane, 1,1-bis(4-hydroxyphenyl)-3,3,5-trimethylcyclohexane, 4,4′-dihydroxydiphenyl sulfide, 4,4′-dihydroxydiphenyl sulfone, and also the di- and tetrabrominated or chlorinated derivatives thereof, for example 2,2-bis(3-chloro-4-hydroxyphenyl) propane, 2,2-bis(3,5-dichloro-4-hydroxyphenyl) propane or 2,2-bis(3,5-dibromo-4-hydroxyphenyl) propane.

These diphenols may be employed individually or in the form of any desired mixtures. The diphenols are known from the literature or obtainable by processes known from the literature.

Polycarbonates employed according to the invention preferably contain at least 20% by weight, more preferably at least 50% by weight, particularly preferably at least 80% by weight, most preferably 100% by weight, in each case based on the sum of all structural units derived from bisphenols, of such structural units derived from bisphenol A.

Examples of chain terminators suitable for the production of the polycarbonates include phenol, p-chlorophenol, p-tert-butylphenol or 2,4,6-tribromophenol, and also long-chain alkylphenols such as 4-[2-(2,4,4-trimethylpentyl)]phenol, 4-(1,3-tetramethylbutyl) phenol according to DE-A 2 842 005 and monoalkylphenol or dialkylphenols having a total of from 8 to 20 carbon atoms in the alkyl substituents, for example 3,5-di-tert-butylphenol, p-isooctylphenol, p-tert-octylphenol, p-dodecylphenol and 2-(3,5-dimethylheptyl) phenol and 4-(3,5-dimethylheptyl) phenol. The amount of employable chain terminators is generally between 0.5 mol % and 10 mol % based on the molar sum of the diphenols employed in each case.

The thermoplastic aromatic polycarbonates have average molecular weights (weight average Mw) of preferably 20 000 to 40 000 g/mol, more preferably 24 000 to 32 000 g/mol, particularly preferably 26 000 to 30 000 g/mol, measured by GPC (gel permeation chromatography) using dichloromethane as solvent, calibration with linear polycarbonates (consisting of bisphenol A and phosgene) of known molar mass distribution from PSS Polymer Standards Service GmbH, Germany, and calibration according to method 2301-0257502-09D (2009 edition in German language) from Currenta GmbH & Co. OHG, Leverkusen. The eluent is dichloromethane. Column combination of crosslinked styrene-divinylbenzene resins. Diameter of analytical columns: 7.5 mm; length: 300 mm. Particle sizes of column material: 3 μm to 20 μm. Concentration of solutions: 0.2% by weight. Flow rate: 1.0 ml/min, temperature of solutions: 30° C. Use of UV and/or RI detection.

The preferred ranges result in a particularly advantageous balance of mechanical and rheological properties in the compositions of the invention.

The polycarbonates may be branched in known fashion and preferably through incorporation of 0.05 to 2.0 mol %, based on the sum of the employed diphenols, of trifunctional or more than trifunctional compounds, for example those having three or more phenolic groups. It is preferable to employ linear polycarbonates, more preferably those based on bisphenol A.

Both homopolycarbonates and copolycarbonates are suitable. Inventive copolycarbonates according to component A may also be produced using 1% to 25% by weight, preferably 2.5% to 25% by weight, based on the total amount of diphenols to be used, of polydiorganosiloxanes having hydroxyaryloxy end groups. These are known (U.S. Pat. No. 3,419,634) and can be produced by processes known from the literature. Likewise suitable are polydiorganosiloxane-containing copolycarbonates, production of the polydiorganosiloxane-containing copolycarbonates being described in DE-A 3 334 782 for example.

Aromatic dicarbonyl dihalides for the production of polyester carbonates are preferably the diacyl dichlorides of isophthalic acid, of terephthalic acid, of diphenyl ether 4,4′-dicarboxylic acid and of naphthalene-2,6-dicarboxylic acid. Particular preference is given to mixtures of the diacyl dichlorides of isophthalic acid and terephthalic acid in a ratio of between 1:20 and 20:1.

Production of polyester carbonates additionally employs a carbonyl halide, preferably phosgene, as a bifunctional acid derivative.

In addition to the aforementioned monophenols, contemplated chain terminators for production of the polyester carbonates also include the chlorocarbonic esters thereof and the acyl chlorides of aromatic monocarboxylic acids, which may optionally be substituted by C₁ to C₂₂ alkyl groups or by halogen atoms, and aliphatic C₂ to C₂₂ monocarbonyl chlorides.

The amount of chain terminators is in each case 0.1 to 10 mol %, based on moles of diphenol in the case of the phenolic chain terminators and on moles of dicarbonyl dichloride in the case of monocarbonyl chloride chain terminators.

Production of polyester carbonates may also employ one or more aromatic hydroxycarboxylic acids.

The polyester carbonates may be either linear or else branched in known fashion (see DE-A 2 940 024 and DE-A 3 007 934), wherein linear polyester carbonates are preferred.

Employable branching agents include for example tri- or polyfunctional carboxylic acid chlorides, such as trimesyl trichloride, cyanuric trichloride, 3,3′,4,4′-benzophenonetetracarboxylic acid tetrachloride, 1,4,5,8-naphthalenetetracarboxylic acid tetrachloride or pyromellitic tetrachloride, in amounts of 0.01 to 1.0 mol % (based on employed dicarboxylic acid dichlorides), or tri- or polyfunctional phenols, such as phloroglucinol, 4,6-dimethyl-2,4,6-tri (4-hydroxyphenyl) hept-2-ene, 4,6-dimethyl-2,4,6-tri (4-hydroxyphenyl) heptane, 1,3,5-tri (4-hydroxyphenyl)benzene, 1,1,1-tri (4-hydroxyphenyl) ethane, tri (4-hydroxyphenyl)phenylmethane, 2,2-bis [4,4-bis(4-hydroxyphenyl)-cyclohexyl]propane, 2,4-bis(4-hydroxyphenylisopropyl) phenol, tetra(4-hydroxyphenyl) methane, 2,6-bis(2-hydroxy-5-methylbenzyl)-4-methylphenol, 2-(4-hydroxyphenyl)-2-(2,4-dihydroxy-phenyl) propane, tetra(4-[4-hydroxyphenylisopropyl]phenoxy) methane, 1,4-bis [4,4′-dihydroxy-triphenyl)methyl]benzene, in amounts of 0.01 to 1.0 mol % based on employed diphenols. Phenolic branching agents may be initially charged with the diphenols; acid chloride branching agents may be introduced together with the acid dichlorides.

The proportion of carbonate structural units in the polyester carbonates may be varied as desired. It is preferable when the proportion of carbonate groups is up to 90 mol %, especially up to 80 mol %, particularly preferably up to 50 mol %, based on the sum of ester groups and carbonate groups. Both the ester fraction and the carbonate fraction of the polyester carbonates may be present in the form of blocks or have a random distribution in the polycondensate.

The polycarbonates and polyester carbonates may be employed alone or in any desired mixture.

It is preferable to employ linear polycarbonate based on exclusively bisphenol A as component A.

### Component B

As component B the molding compound according to the invention contains at least one further polymer distinct from component A or a mixture consisting of polymers that are each distinct from component A,
wherein component B consists of
B1) at least one thermoplastic polymer and
optionally B2) at least one non-thermoplastic polymer
and wherein the weight fraction of component B1 in component B is at least 20%, preferably at least 50%, more preferably at least 70% by weight.

A mixture of polymers may mean that the corresponding pellet materials or powders consisting of the polymers are distributed in one another as homogeneously as possible. This may be achieved by filling the pellet materials or powders into suitable mixing apparatuses or containers and achieving mixing without necessarily effecting melting of one or more polymers for example by shaking or stirring at room temperature, at elevated temperature or alternatively also with cooling.

A mixture of polymers can also be understood as meaning a compound (polymer blend) obtained by melting one or more polymers by introducing thermal or mechanical energy and mixing the polymers in the melt. Melting and mixing may be effected in an extruder or kneader for example.

Numerous commercially available thermoplastically processible materials are mixtures of thermoplastic and non-thermoplastic polymers obtained by melt compounding. This is the case, for example, for many commercially available ABS (acrylonitrile-butadiene-styrene) plastics for injection molding or extrusion applications which are often obtained industrially by compounding thermoplastic styrene-acrylonitrile copolymers (SAN) with non-thermoplastic ABS graft emulsion polymers.

Component B is preferably selected from the group consisting of rubber-free vinyl (co)polymers, rubber-modified vinyl (co)polymers, polyolefins, polyamides, polyesters, polycarbonates distinct from component A and high temperature polymers such as for example polysulfones, polyimides, polyphenylenes, polyaryls, polyether ketones, polyphenylene sulfides and mixtures of in each case one or more of such polymers, more preferably selected from the group consisting of rubber-free vinyl (co)polymers, rubber-modified vinyl (co)polymers, aromatic polyesters and mixtures of in each case one or more of such polymers, most preferably selected from the group consisting of rubber-free vinyl (co)polymers, rubber-modified vinyl (co)polymers and mixtures of in each case one or more of such polymers.

Polyolefins employable as component B are produced by chain polymerization, preferably by free-radical polymerization. Monomers employed include alkenes. An alternative name for alkenes is olefins. The monomers may be polymerized individually or as a mixture of various monomers.

Preferred monomers are ethylene, propylene, 1-butene, isobutene, 1-pentene, 1-heptene, 1-octene. and 4-methyl-1-pentene.

The polyolefins may contain up to 50% by weight, more preferably up to 30% by weight, of vinylic comonomers, for example methyl acrylate, ethyl acrylate, butyl acrylate and methyl methacrylate.

The polyolefins are semicrystalline or amorphous and may be linear or branched. The production of polyolefins has long been known to those skilled in the art.

The polymerization may be carried out for example at pressures of from 1 to 3000 bar and temperatures between 20° C. and 300° C., optionally with use of a catalyst system. Examples of suitable catalysts include mixtures of titanium and aluminum compounds, and metallocenes.

By altering the polymerization conditions and the catalyst system, the number of branches, the crystallinity, and the density of the polyolefins can be varied within wide ranges. These measures are also familiar to those skilled in the art.

Employable components B or constituents of component B also include rubber-modified vinyl (co)polymers or rubber-free vinyl (co)polymers or a mixture of two or more such polymers.

The rubber-modified vinyl (co)polymer is preferably selected from rubber-modified graft polymers. Depending on their rubber content these may be either thermoplastic (according to component B1) or non-thermoplastic (according to component B2). Typically, rubber-modified graft polymers having a rubber content of greater than 40% by weight alone, i.e. without addition of further polymers, for example further sub-components B which are thermoplastically processible, for example rubber-free or low-rubber sub-components B, are generally no longer thermoplastically processible.

If process step (i) employs as component B or as part of component B a precompound of at least one thermoplastic polymer according to component B1 and at least one non-thermoplastic polymer according to component B2, for example a precompound of one or more rubber-free or low-rubber vinyl (co)polymers and one or more rubber-modified graft polymers having respective rubber contents of greater than 40% by weight, the calculation of the weight fraction of component B1 in component B in the inventive composition shall take into account only the corresponding weight fraction of B1 in the precompound as thermoplastic polymer B1 even if the precompound as such is itself thermoplastic.

The rubber-modified graft polymers may have a core-shell structure for example. Such rubber-modified graft polymers having a core-shell structure are typically produced by emulsion polymerization and generally have a rubber content in the range from 20% to 90% by weight, preferably 30% to 85% by weight, more preferably 40% to 80% by weight. Due to their high rubber content such rubber-modified graft polymers having a core-shell structure, especially those having a rubber content of greater than 40% by weight, are often insufficiently thermoplastically processible and in the context of the present invention are generally not suitable as a sole component B in the production of the masterbatch in inventive process step (i). However, as a constituent of component B they may be employed in the production of the masterbatch in a mass fraction of up to 50% by weight, preferably up to 40% by weight, more preferably up to 30% by weight, in each case based on component B. If the inventive polycarbonate blend compositions are to employ higher usage amounts than the aforementioned usage amounts of rubber-modified graft polymers having a core shell structure, based on the component B, these additional amounts may be added in process step (ii) of the inventive production process.

Further rubber-modified graft polymers suitable according to the invention are those which, as a consequence of their production, contain a disperse phase consisting of vinyl (co)polymer-grafted rubber particles containing inclusions of vinyl (co)polymer embedded in a vinyl (co)polymer matrix. Such rubber-modified graft polymers are obtainable by bulk polymerization.

Rubber-modified vinyl (co)polymers employed as component B comprise
5% to 95% by weight, preferably 15% to 92% by weight, especially 20% to 60% by weight, based on the rubber-modified vinyl (co)polymer, of at least one vinyl monomer as the graft superstrate (graft shell) on
95% to 5% by weight, preferably 85% to 8% by weight, especially 80% to 40% by weight, based on the rubber-modified vinyl (co)polymer, of one or more rubber-like graft substrates preferably having glass transition temperatures <10° C., more preferably <0° C., particularly preferably <−20° C.

The glass transition temperature is measured by means of dynamic differential calorimetry (DSC) to the standard DIN EN 61006 at a heating rate of 10 K/min, with definition of the Tg as the midpoint temperature (tangent method).

The graft substrate generally has a median particle size (d₅₀) of 0.05 to 10 μm, preferably 0.1 to 5 μm, particularly preferably 0.2 to 1 μm.

The median particle size d₅₀ is the diameter with 50% by weight of the particles above it and 50% by weight of the particles below it. It is determinable by ultracentrifuge measurement (W. Scholtan, H. Lange, Kolloid, Z. and Z. Polymere 250 (1972), 782-1796).

Vinyl monomers for producing the rubber-modified vinyl (co)polymers are preferably mixtures of
50 to 99, preferably 60 to 80, especially 70 to 80 parts by weight, based on the graft superstrate, of vinylaromatics and/or ring-substituted vinylaromatics (such as styrene, α-methylstyrene, p-methylstyrene, p-chlorostyrene) and/or (C₁-C₈) alkyl methacrylates, such as methyl methacrylate, ethyl methacrylate), preferably selected from at least one of the monomers styrene, «-methylstyrene and methyl methacrylate, particularly preferably styrene, and
1 to 50, preferably 20 to 40, especially 20 to 30, parts by weight based on the graft superstrate of vinyl cyanides (unsaturated nitriles such as acrylonitrile and methacrylonitrile) and/or (C₁-C₈) alkyl (meth)acrylates, such as methyl methacrylate, n-butyl acrylate, tert-butyl acrylate and/or derivatives (such as anhydrides and imides) of unsaturated carboxylic acids, for example maleic anhydride and N-phenylmaleimide, preferably selected from at least one of the monomers acrylonitrile, maleic anhydride and methyl methacrylate, particularly preferably acrylonitrile.

In a further preferred embodiment the graft superstrate consists of methyl methacrylate.

Graft substrates suitable for the rubber-modified vinyl (co)polymers are for example diene rubbers, EP (D) M rubbers, i.e. those based on ethylene/propylene and optionally diene, acrylate, polyurethane, silicone, chloroprene, and ethylene/vinyl acetate rubbers and also silicone/acrylate composite rubbers.

Preferred graft substrates are diene rubbers, for example based on butadiene and isoprene, or mixtures of diene rubbers or copolymers of diene rubbers or mixtures thereof with further copolymerizable monomers (for example the vinyl polymers also employed for the graft superstrate).

A particularly preferred graft substrate is pure polybutadiene rubber.

Particularly preferred rubber-modified vinyl (co)polymers are for example ABS or MBS polymers as described for example in DE-A 2 035 390 (=US-B 644 574) or in DE-A 2 248 242 (=GB-B 1 409 275), or in Ullmanns Enzyklopädie der Technischen Chemie, Vol. 19 (1980), p. 280 ff.

The rubber-modified vinyl (co)polymers are produced by free-radical polymerization, for example by emulsion, suspension, solution or bulk polymerization, preferably by emulsion or bulk polymerization.

The gel content of the graft substrate is at least 30% by weight, preferably at least 40% by weight, in particular at least 60% by weight, measured as the insoluble proportion in toluene.

The gel content of the graft substrate is determined at 25° C. in a suitable solvent as the proportion insoluble in these solvents (M. Hoffmann, H. Krömer, R. Kuhn, Polymeranalytik I und II, Georg Thieme-Verlag, Stuttgart 1977).

Particularly suitable graft rubbers are also ABS polymers produced by redox initiation with an initiator system consisting of organic hydroperoxide and ascorbic acid according to U.S. Pat. No. 4,937,285.

Since, as is well known, the graft monomers are not necessarily entirely grafted onto the graft substrate in the grafting reaction, in accordance with the invention graft polymers are also understood to mean products which are produced via (co)polymerization of the graft monomers in the presence of the graft substrate and coobtained in the workup. These products may accordingly also comprise free (co)polymer of the graft monomers, i.e. (co)polymer not chemically bonded to the rubber.

Acrylate rubbers suitable as graft substrates are preferably polymers of alkyl acrylates, optionally with up to 40% by weight, based on the graft substrate, of other polymerizable ethylenically unsaturated monomers. Preferred polymerizable acrylic esters include C₁- to C₈-alkyl esters, for example methyl, ethyl, butyl, n-octyl and 2-ethylhexyl esters; haloalkyl esters, preferably halo-C₁-C₈-alkyl esters, such as chloroethyl acrylate and also mixtures of these monomers.

Further suitable graft substrates are silicone rubbers having graft-active sites, such as are described in DE-A 3 704 657, DE-A 3 704 655, DE-A 3 631 540 and DE-A 3 631 539.

The rubber-free vinyl (co)polymers are preferably rubber-free homo- and/or copolymers of at least one monomer from the group of vinylaromatics, vinyl cyanides (unsaturated nitriles), (C₁ to C₈)alkyl (meth)acrylates, unsaturated carboxylic acids, and derivatives (such as anhydrides and imides) of unsaturated carboxylic acids.

Especially suitable are rubber-free vinyl (co)polymers of
50% to 99% by weight, preferably 60% to 80% by weight, in particular 70% to 80% by weight, in each case based on the total weight of the rubber-free vinyl (co)polymer, of at least one monomer selected from the group of vinylaromatics, for example styrene, α-methylstyrene, ring-substituted vinylaromatics, for example p-methylstyrene, p-chlorostyrene and (C₁-C₈) alkyl (meth)acrylates, for example methyl methacrylate, n-butyl acrylate, tert-butyl acrylate and
1% to 50% by weight, preferably 20% to 40% by weight, especially 20% to 30% by weight, in each case based on the total weight of the rubber-free vinyl (co)polymer, of at least one monomer selected from the group of vinyl cyanides, for example unsaturated nitriles such as for example acrylonitrile and methacrylonitrile, (C₁-C₈) alkyl (meth)acrylates, for example methyl methacrylate, n-butyl acrylate, and tert-butyl acrylate, unsaturated carboxylic acids and derivatives of unsaturated carboxylic acids, for example maleic anhydride and N-phenylmaleimide.

These rubber-free vinyl (co)polymers are resinous and thermoplastic. It is particularly preferable when the copolymer is a copolymer of styrene and acrylonitrile.

Such rubber-free vinyl (co)polymers are known and may be produced by free-radical polymerization, especially by emulsion, suspension, solution or bulk polymerization. It is preferable when the rubber-free vinyl (co)polymers have average molecular weights Mw (weight average, determined by GPC with a polystyrene standard) between 15 000 and 250 000 g/mol, preferably in the range 80 000 to 150 000 g/mol.

In a preferred embodiment aromatic polyesters suitable as component B are polyalkylene terephthalates. In a particularly preferred embodiment, they are reaction products of aromatic dicarboxylic acids or reactive derivatives thereof, such as dimethyl esters or anhydrides, and aliphatic, cycloaliphatic or araliphatic diols and also mixtures of these reaction products. Particularly preferred aromatic polyalkylene terephthalates contain at least 80% by weight, preferably at least 90% by weight, based on the dicarboxylic acid component, of terephthalic acid moieties and at least 80% by weight, preferably at least 90% by weight, based on the diol component, of ethylene glycol moieties and/or butane-1,4-diol moieties.

In addition to terephthalic acid radicals, the preferred aromatic polyalkylene terephthalates may comprise up to 20 mol %, preferably up to 10 mol %, of radicals of other aromatic or cycloaliphatic dicarboxylic acids having 8 to 14 carbon atoms or of aliphatic dicarboxylic acids having 4 to 12 carbon atoms, for example radicals of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid.

In addition to ethylene glycol and/or butane-1,4-diol moieties, the preferred aromatic polyalkylene terephthalates may contain up to 20 mol %, preferably up to 10 mol %, of other aliphatic diols having 3 to 12 carbon atoms or cycloaliphatic diols having 6 to 21 carbon atoms, for example propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di(β-hydroxyethoxy)-benzene, 2,2-bis(4-hydroxycyclohexyl) propane, 2,4-dihydroxy-1,1,3,3-tetramethylcyclobutane, 2,2-bis(4-β-hydroxyethoxyphenyl) propane or 2,2-bis(4-hydroxypropoxyphenyl) propane moieties (DE-A 2 407 674, 2 407 776, 2 715 932).

The aromatic polyalkylene terephthalates may be branched through incorporation of relatively small amounts of tri- or tetrahydric alcohols or tri- or tetrabasic carboxylic acids, for example according to DE-A 1 900 270 and US-PS 3 692 744. Examples of preferred branching agents are trimesic acid, trimellitic acid, trimethylolethane and trimethylolpropane, and pentaerythritol.

Particular preference is given to aromatic polyalkylene terephthalates produced solely from terephthalic acid and reactive derivatives thereof (for example the dialkyl esters thereof) and ethylene glycol and/or butane-1,4-diol, and to mixtures of these polyalkylene terephthalates.

Preferred mixtures of aromatic polyalkylene terephthalates contain 1% to 50% by weight, preferably 1% to 30% by weight, of polyethylene terephthalate and 50% to 99% by weight, preferably 70% to 99% by weight, of polybutylene terephthalate.

The preferably employed aromatic polyalkylene terephthalates have a viscosity number of 0.4 to 1.5 dl/g, preferably 0.5 to 1.2 dl/g, measured in phenol/o-dichlorobenzene (1:1 parts by weight) at a concentration of 0.05 g/ml according to ISO 307 at 25° C. in an Ubbelohde viscometer.

The aromatic polyalkylene terephthalates can be produced by known methods (see for example Kunststoff-Handbuch, volume VIII, p. 695 ff., Carl-Hanser-Verlag, Munich 1973).

Components B employed with greatest preference are copolymers of styrene and acrylonitrile (SAN), ABS copolymers or mixtures containing ABS and/or SAN, optionally in combination with further rubber-modified vinyl (co)polymers, preferably in combination with graft polymers having a core-shell structure.

### Component C

As component C the composition preferably contains at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and also combinations of the recited fillers. Preferred compositions contain talc as a constituent of component C. In particularly preferred compositions exclusively talc is employed as component C in addition to inorganic pigments optionally employed for coloring.

Suitable quartz compounds include for example those consisting of more than 97% by weight of silicon dioxide (quartz). Their particle shape is spherical and/or approximately spherical.

In a preferred embodiment quartzes having a coating with organosilicon compounds are employed, it being preferable to employ epoxysilane, methylsiloxane and/or methacryloylsilane sizes. Particular preference is given to an epoxysilane size.

Sizing inorganic fillers is carried out according to the general methods known to those skilled in the art.

Preferred quartz compounds are finely divided (amorphous) fused quartz flours produced from electrically molten silicon dioxide by iron-free grinding with subsequent wind sifting. It is likewise possible to employ quartz flours produced from treated quartz sand.

Commercially available fused quartz flours include for example Amosil™ FW600 or Amosil™ FW600 from Quarzwerke GmbH (Germany). Commercially available quartz flours include for example Sikron™ SF300, Sikron™ SF600, Sikron™ SF800, Silbond™ SF600 EST from Quarzwerke GmbH (Germany) or Mikro-Dorsilit™ 120 from QUARZSANDE GmbH (Austria).

Preferred inorganic fillers are mineral fillers based on talc. Suitable talc-based mineral fillers in the context of the present invention include any fillers that a person skilled in the art associates with talc or talcum. Also suitable are all fillers that are commercially available and whose product descriptions contain as characterizing features the terms talc or talcum. In the context of the present invention mineral fillers based on talc are also referred to simply as talc.

Mixtures of various mineral fillers based on talc can also be used.

According to the invention preference is given to mineral fillers having a content of talc according to DIN 55920 (2006 version) of greater than 80% by weight, preferably greater than 95% by weight and particularly preferably greater than 98% by weight based on the total mass of the filler.

Talc is to be understood as meaning a naturally occurring or synthetically produced talc. Pure talc is a silicate having a layered structure.

The talc types employed as component C preferably feature a particularly high purity, characterized by an MgO content of 28% to 35% by weight, preferably 30% to 33% by weight, particularly preferably 30.5% to 32% by weight, and an SiO₂ content of 55% to 65% by weight, preferably 58% to 64% by weight, particularly preferably 60% to 62.5% by weight. The particularly preferred talc grades further feature an Al₂O₃ content of less than 5% by weight, more preferably less than 1% by weight, especially less than 0.7% by weight.

Especially also advantageous and thus preferred is the use of the talc according to the invention in the form of finely ground grades having a median particle size d₅₀ of 0.2 to 10 μm, preferably 0.5 to 5 μm, more preferably 0.7 to 2.5 μm and particularly preferably 1.0 to 2.0 μm.

The median particle size d₅₀ is the diameter with 50% by weight of the particles above it and 50% by weight of the particles below it. It is also possible to use mixtures of talc grades which differ in their d₅₀ median particle size.

The talc grades to be used according to the invention preferably have an upper particle or grain size d₉₇ below 50 μm, preferably below 10 μm, particularly preferably below 6 μm and especially preferably below 2.5 μm.

The d₉₇ and d₅₀ values of component C are determined-unless otherwise stated—by sedimentation analysis using a Sedigraph 5100 (Micromeritics GmbH, Erftstrasse 43, 41238 Mönchengladbach, Germany) in accordance with ISO 13317-1 and ISO 13317-3 (2000 version).

The talc may be surface-treated, for example silanized, to ensure better compatibility with the polymer. The talc may, for example, have been modified with an adhesion promoter system based on functionalized silanes.

In respect of the processing and production of the molding compounds it is also advantageous to use a compacted talc.

As a result of the processing to afford the molding compound/molded articles the employed talc may have a smaller d₉₇/d₅₀ in the molding compound/in the molded article than in the originally employed form.

It is also possible to employ kaolin, preferably a surface-treated calcined kaolin, as component B.

The primary constituent of the naturally occurring kaolin is kaolinite, Al2(OH)4[Si2O5] and secondary constituents are feldspars, mica and quartz. In addition to this composition it is also possible to employ kaolins which instead of or in addition to kaolinite also contain nacrite, dickite, halloysite and hydrated halloysite.

The calcined kaolin according to the invention is obtained by heat treatment of a kaolin at at least 500° C., preferably from 850° C. to 1100° C. The hydroxyl groups, which form part of the crystal structure of kaolin, are lost during this heat treatment and the kaolin is converted into calcined kaolin.

It is further also possible according to the invention to employ wollastonites. These preferably have a carbon content based on the wollastonite of greater than 0.1% by weight, preferably 0.2% to 2% by weight, particularly preferably 0.3% to 1% by weight, very particularly preferably 0.3% to 0.6% by weight, determined by elemental analysis. Such wollastonites are commercially available, for example under the trade name Nyglos™ from NYCO Minerals Inc. Willsboro, NY, USA and the type designations Nyglos™ 4-10992 or Nyglos™ 5-10992.

Preferred wollastonites have an average aspect ratio, i.e. a ratio of the average length of the fiber to the average diameter, of >6, in particular ≥7, and an average fiber diameter of 1 to 15 μm, preferably 2 to 10 μm, in particular from 4 to 8 μm.

A further suitable filler is calcium carbonate CaCO₃. Calcium carbonate occurs naturally in the form of minerals such as calcite, aragonite and vaterite, as well as being the primary constituent of limestone, chalk and marble. Calcium carbonate may also be produced by synthesis, which can be advantageous on account of the higher purity. It is preferable to employ calcium carbonate having an average particle diameter d₅₀ of 0.1 to 5 μm.

Another suitable filler is aluminum hydroxide Al(OH)₃. Aluminum hydroxide occurs naturally in the form of minerals such as gibbsite, bayerite and nordstrandite. Aluminum hydroxide may also be produced by synthetic means which can be beneficial on account of the higher purity. It is preferable to employ calcium carbonate having an average particle diameter d₅₀ of 1 to 5 μm.

A further suitable filler is mica, preferably metal oxide-coated mica. The mica may be naturally occurring or synthetically produced mica, the latter being preferable owing to its typically higher purity. Mica which is obtained from nature is typically accompanied by further minerals. In the case of mica obtained from nature, the reported amount of component B “mica” also includes relevant impurities. The mica is preferably muscovite-based, i.e. it preferably comprises at least 60% by weight, more preferably at least 70% by weight, yet more preferably at least 85% by weight, particularly preferably at least 90% by weight, of muscovite, based on the total weight of the mica content.

The metal oxide coating preferably comprises one or more coating layers containing titanium dioxide, tin oxide, aluminum oxide and/or iron oxide, wherein the metal oxide is more preferably iron (III) oxide (Fe2O3), iron (II, III) oxide (Fe3O4, a mixture of Fe2O3 and FeO) and/or titanium dioxide, particularly preferably titanium dioxide.

The median particle size (d₅₀) of the pigment, determined by laser diffractometry on an aqueous slurry of the pigment, is preferably 1 to 100 μm, more preferably 5 to 80 μm for synthetic mica and more preferably 3 to 30 μm for natural mica, generally for mica particularly preferably 3.5 to 15 μm, very particularly preferably 4.0 to 10 μm, most preferably 4.5 to 8.0 μm.

Commercially available suitable micas include for example products of the product group Tremica™ from HPF Minerals (Quarzwerke Gruppe, Germany).

As component C it is preferably also possible to employ one or more pigments based on titanium dioxide, optionally in combination with other inorganic pigments such as for example iron oxide, aquamarine, ultramarine blue, zinc white and zinc oxide.

Naturally occurring, synthetically produced or modified naturally occurring pigments or mixtures thereof are concerned. The titanium dioxide pigments preferably have a crystal structure modification selected from rutile, anatase or brookite. The preferred modification is rutile.

Inventive pigments based on titanium dioxide have a density (according to DIN EN ISO 787-10) of 3.6 to 4.4 g/cm³, preferably of 3.8 to 4.3 g/cm³, particularly preferably of 4.0 to 4.2 g/cm³.

The pigments may be derived in a known manner by the sulphate process or the chloride process from natural raw materials such as ilmenite, rutil ore or TiO₂ slag.

The pigments may have an inorganic and/or organic surface modification, preferably based on aluminum and/or polysiloxane compounds. The proportion of titanium dioxide (according to DIN EN ISO 591) is preferably >90% by weight, particularly preferably >92% by weight, more preferably >95% by weight.

In preferred embodiments the pigments have an oil absorption (according to ISO787-5) of 5 to 50 g/100 g of pigment, more preferably of 10 to 25 g/100 g of pigment and particularly preferably of 12 to 18 g/100 g of pigment.

### Component D

As component D the composition may contain one or more non-polymeric polymer additives and/or non-polymeric processing auxiliaries distinct from component C, preferably selected from the group consisting of flame retardants, anti-drip agents, flame retardant synergists, smoke inhibitors, lubricants and demolding agents, nucleating agents, antistats, conductivity additives, stabilizers (for example hydrolysis, heat aging and UV stabilizers and also transesterification inhibitors), flow promoters, phase compatibilizers, organic fillers and reinforcers and organic dyes and pigments.

In a preferred embodiment, fatty acid esters, particularly preferably fatty acid esters of pentaerythritol or glycerol, are employed as lubricants and demolding agents.

In a preferred embodiment at least one representative selected from the group consisting of sterically hindered phenols, organic phosphites and sulfur-based co-stabilizers is used as a stabilizer.

In a particularly preferred embodiment at least one representative selected from the group consisting of octadecyl-3-(3,5-di-tert-butyl-4-hydroxyphenyl) propionate and tris(2,4-di-tert-butylphenyl)-phosphite is used as a stabilizer.

### Process for Producing the Molding Compounds

The process according to the invention produces thermoplastic molding compounds having a low mass content of free BPA from the inventive components A, B and C and optionally D.

The term “molding compound” is to be understood as meaning the product obtained when the constituents of the composition are melt-compounded and melt-extruded.

The invention also provides a corresponding process for producing the molding compounds according to the invention as described above.

The molding compounds of the invention may be used to produce shaped articles of any kind. These may be produced for example by injection molding, extrusion, and blow-molding processes. A further form of processing is the production of molded articles by thermoforming from previously produced sheets or films.

Examples of such shaped articles are films, profiles, housing parts of any type, for example for domestic appliances such as juice presses, coffee machines, mixers; for office machinery such as monitors, flatscreens, notebooks, printers, copiers; sheets, pipes, electrical installation ducts, windows, doors and other profiles for the construction sector (internal fitout and external applications), and also electrical and electronic components such as switches, plugs and sockets, and component parts for commercial vehicles, in particular for the automotive sector. The compositions and molding compounds according to the invention are also suitable for producing the following shaped articles or molded parts: internal fitout parts for rail vehicles, ships, aircraft, buses and other motor vehicles, bodywork components for motor vehicles, housings of electrical equipment containing small transformers, housings for equipment for the processing and transmission of information, housings and facings for medical equipment, massage equipment and housings therefor, toy vehicles for children, sheetlike wall elements, housings for safety equipment, thermally insulated transport containers, molded parts for sanitation and bath equipment, protective grilles for ventilation openings and housings for garden equipment.

Preference is given to the following embodiments in particular:

1. Thermoplastic molding compound containing
A) at least one polycarbonate and/or polyester carbonate in each case containing structural units derived from bisphenol A,
B) a further polymer distinct from component A or a mixture consisting of polymers in each case distinct from component A, wherein component B consists of
B1) at least one thermoplastic polymer and optionally B2) at least one non-thermoplastic polymer,
C) at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and combinations of the recited fillers and
D) optionally at least one non-polymeric polymer additive and/or at least one non-polymeric process auxiliary in each case distinct from component C,
wherein the weight ratio of component B to component C is at least 0.5
and wherein the weight fraction of component B1 in component B is at least 20%
and wherein the molding compound has a mass fraction of free bisphenol A of less than 30 ppm.

2. Molding compound according to embodiment 1, wherein the weight ratio of component B to component C is at least 1.

3. Molding compound according to embodiment 1, wherein the weight ratio of component B to component C is at least 1.3.

4. Molding compound according to any of the preceding embodiments containing 30% to 85% by weight of component A,
2% to 50% by weight of component B,
3% to 40% by weight of component C,
0% to 10% by weight of component D.

5. Molding compound according to any of the preceding embodiments containing
40% to 80% by weight of component A,
7% to 40% by weight of component B,
5% to 30% by weight of component C,
0.1% to 5% by weight of component D.

6. Molding compound according to any of the preceding embodiments containing
45% to 75% by weight of component A,
15% to 35% by weight of component B,
8% to 25% by weight of component C,
0.2% to 3% by weight of component D.

7. Molding compound according to any of the preceding embodiments, wherein the weight ratio of component B to component C is 0.5 to 5.

8. Molding compound according to any of the preceding embodiments, wherein the weight ratio of component B to component C is 1 to 3.

9. Molding compound according to any of the preceding embodiments, wherein the weight ratio of component B to component C is 1.3 to 2.

10. Molding compound according to any of the preceding embodiments, wherein component C contains talc.

11. Molding compound according to any of the preceding embodiments, wherein component B is selected from the group consisting of rubber-free vinyl (co)polymers, rubber-modified vinyl (co)polymers, aromatic polyesters and mixtures of in each case one or more such polymers.

12. Molding compound according to any of the preceding embodiments, wherein component B is selected from the group consisting of rubber-free vinyl (co)polymers, rubber-modified vinyl (co)polymers and mixtures of in each case one or more such polymers.

13. Molding compound according to any of the preceding embodiments, wherein the mass fraction of free bisphenol A is less than 20 ppm.

14. Molding compound according to any of the preceding embodiments, wherein the mass fraction of free bisphenol A is less than 10 ppm.

15. Molding compound according to any of the preceding embodiments, wherein the weight fraction of component B1 in component B is at least 50%.

16. Molding compound according to any of the preceding embodiments, wherein the weight fraction of component B1 in component B is at least 70%.

17. Molding compound according to any of the preceding embodiments, wherein component A contains at least 20% by weight, based on the sum of all structural units derived from bisphenols, of structural units derived from bisphenol A.

18. Molding compound according to any of the preceding embodiments, wherein component A contains 100% by weight, based on the sum of all structural units derived from bisphenols, of structural units derived from bisphenol A.

19. Molding compound according to any of the preceding embodiments consisting of components A, B, C and D.

20. Process for producing a thermoplastic molding compound comprising the steps of
(i) producing a masterbatch by melt compounding the following components in an internal kneader or a co-kneader:
B) a polymer distinct from polycarbonate containing structural units derived from bisphenol A and distinct from polyester carbonate containing structural units derived from bisphenol A or a mixture consisting of polymers distinct from polycarbonate containing structural units derived from bisphenol A and distinct from polyester carbonate containing structural units derived from bisphenol A,
wherein component B consists of
B1) at least one thermoplastic polymer and optionally B2) at least one non-thermoplastic polymer
C) at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and combinations of the recited fillers and
D) optionally a non-polymeric polymer additive and/or at least one non-polymeric process auxiliary, in each case distinct from component C,
wherein the weight ratio of component B to component C is at least 0.5 and
wherein the weight fraction of component B1 in component B is at least 50%
(ii) melt compounding the masterbatch obtained in step (i) with at least one polycarbonate and/or polyester carbonate in each case containing structural units derived from bisphenol A as component A and optionally further proportions of components B, C and/or D and/or the total amount of component D.

21. Process according to embodiment 20, wherein component B is selected from the group consisting of rubber-free vinyl (co)polymers, rubber-modified vinyl (co)polymers, aromatic polyesters and mixtures of in each case one or more such polymers.

22. Process according to embodiment 20, wherein component B is selected from the group consisting of rubber-free vinyl (co)polymers, rubber-modified vinyl (co)polymers and mixtures of in each case one or more such polymers.

23. Process according to any of embodiments 20 to 22, wherein the weight ratio of component B to component C is at least 1.

24. Process according to any of embodiments 20 to 22, wherein the weight ratio of component B to component C is 0.5 to 5.

25. Process according to any of embodiments 20 to 22, wherein the weight ratio of component B to component C is 1.3 to 2.

26. Process according to any of the preceding embodiments 20 to 25, wherein the weight fraction of component B1 in component B is at least 60%.

27. Process according to any of the preceding embodiments 20 to 25, wherein the weight fraction of component B1 in component B is at least 70%.

28. Process according to any of the preceding embodiments 20 to 27, wherein component C contains talc.

29. Process according to any of the preceding embodiments 20 to 28, wherein at least 80% by weight of the total amount of component C is employed in step (i).

30. Process according to any of the preceding embodiments 20 to 29, wherein the total amount of component C is employed in step (i).

31. Process according to any of the preceding embodiments 20 to 30, wherein step (ii) is performed in a compounding apparatus selected from the group consisting of single-shaft extruders, co-rotating or counter-rotating twin-screw extruders, planetary roller extruders, internal kneaders and co-kneaders.

32. Process according to any of embodiments 20 to 31, wherein steps (i) and (ii) are performed in a temperature range of 200° C. to 350° C. with a residence time of the components in the melt in the range from 15 seconds to 5 minutes.

33. Process according to any of the preceding embodiments 20 to 32, wherein step (i) is performed in a co-kneader.

34. Process according to one of the preceding embodiments 20 to 33, wherein step (ii) is performed in a twin-screw extruder.

35. Process according to embodiment 33, wherein step (i) is performed at a temperature of the melt in the range from 210° C. to 260° C.

36. Process according to embodiment 34, wherein step (ii) is performed at a temperature of the melt in the range from 260° C. to 320° C.

37. Process according to either of embodiments 33 or 35, wherein the residence time of the components in the melt in step (i) is in the range from 1 to 5 minutes.

38. Process according to either of embodiments 33 or 35, wherein the residence time of the components in the melt in step (i) is in the range from 2 to 3.5 minutes.

39. Process according to either of embodiments 34 or 36, wherein the residence time of the components in the melt in step (ii) is in the range from 15 to 60 seconds.

40. Process according to any of the preceding embodiments 20 to 30, wherein step (i) is performed in a co-kneader at a temperature of the melt in the range from 210° C. to 260° C. and with a residence time of the components in the melt in the range from 1 to 5 minutes
and step (ii) is performed in a twin-screw extruder at a temperature of the melt in the range from 260° C. to 320° C. and with a residence time of the components in the melt in the range from 15 to 60 seconds.

41. Use of a thermoplastic molding compound according to any of embodiments 1 to 19 for producing a shaped article.

42. Shaped article containing or consisting of a molding compound according to any of embodiments 1 to 19.

43. Shaped article containing or consisting of a molding compound produced in a process according to any of embodiments 20 to 40.

The invention shall now be more particularly elucidated with reference to the examples which follow, but without restricting it thereto.

### EXAMPLES

### Component A-1:

Linear polycarbonate based on bisphenol A, produced in the interfacial polymerization process, having a weight-average molecular weight Mw of 28 000 g/mol (determined at room temperature by GPC in methylene chloride against a BPA-PC standard).

### Component A-2:

Linear polycarbonate based on bisphenol A, produced in the interfacial polymerization process, having a weight-average molecular weight Mw of 25 000 g/mol (determined at room temperature by GPC in methylene chloride against a BPA-PC standard).

### Component B-1:

Thermoplastic acrylonitrile (A)-butadiene (B)-styrene(S)-n-butyl acrylate (BA) polymer produced in a bulk polymerization process which contains a disperse phase consisting of rubber particles grafted with styrene-acrylonitrile-n-butyl acrylate copolymer and based on pure polybutadiene rubber as a graft substrate containing inclusions of styrene-acrylonitrile-n-butyl acrylate copolymer and a styrene-acrylonitrile-n-butyl acrylate copolymer matrix not bonded to the rubber. Component B-1 has an A:B:S:BA ratio of 22.5:10:63:4.5% by weight and a gel content, determined as the proportion insoluble in acetone, of 19% by weight. The tetrahydrofuran-soluble styrene-acrylonitrile-n-butyl acrylate copolymer in component B-1 has a weight-average molecular weight Mw (measured by GPC in tetrahydrofuran as the solvent using a polystyrene standard) of 115 kg/mol. The median particle size of the disperse phase D50, measured by ultracentrifugation, is 0.5 μm. The melt flow rate (MFR) of component B-1, measured according to ISO 1133 (2012 version) at 220° C. with a piston load of 10 kg, is 28 g/10 min.

### Component B-2:

Non-thermoplastic graft polymer having a core-shell structure produced by emulsion polymerization and consisting of 75% by weight of a silicone-acrylate composite rubber core and 25% by weight of a polymethyl methacrylate shell. Component B-2 has a gel content measured in acetone at room temperature of 90% by weight (Metablen™ S-2030, manufacturer: Mitsubishi Chemical, Japan).

### Component B-3:

Thermoplastic SAN copolymer having an acrylonitrile content of 28% by weight and a weight-average molecular weight of about 130 000 g/mol (determined at room temperature by GPC in tetrahydrofuran using a polystyrene standard).

### Component B-4:

Thermoplastic SAN copolymer having an acrylonitrile content of 23% by weight and a weight-average molecular weight of about 100 000 g/mol (determined at room temperature by GPC in tetrahydrofuran using a polystyrene standard).

### Component B-5

Polyethylene terephthalate (for example PET from Invista, Germany) having an intrinsic viscosity of 0.623 dl/g. The specific viscosity is measured in dichloroacetic acid at a concentration of 1% by weight at 25° C. The intrinsic viscosity is calculated from the specific viscosity according to the following formula:

Intrinsic viscosity=specific viscosity×0.0006907+0.063096

### Component C:

Compacted talc having an iron oxide content of 0.2% by weight, an aluminum oxide content of 0.4% by weight and a calcium oxide content of 0.3% by weight, d₅₀ (sedimentation analysis) of 1.1 μm; type: Jetfine® 3CA, manufacturer: Imerys Performance Additives (Paris, France).

### Component D-1:

pentaerythritol tetrastearate, Loxiol™ P 861/3.5 Special (Emery Oleochemicals GmbH, Düsseldorf, Germany).

### Component D-2:

Irganox™ B900 (mixture of 80% Irgafos™ 168 (tris(2,4-di-tert-butylphenyl) phosphite) and 20% Irganox™ 1076 (2,6-di-tert-butyl-4-(octadecanoxycarbonylethyl) phenol); BASF (Ludwigshafen, Germany).

### Component D-3:

Fabutit™ 289: orthophosphoric acid absorbed on silica gel (Chemische Fabrik Budenheim KG, Germany).

### Component D-4:

Black Pearls™ 800: Carbon black (Cabot Corp., USA)

### Component D-5

Phosphorous acid H₃PO₃ as a solid, Sigma-Aldrich Chemie GmbH, Germany

### Component D-6

Irganox™ 1010 (pentaerythritol tetrakis(3,5-di-tert-butyl-4-hydroxyhydrocinnamate); BASF (Ludwigshafen, Germany)

### Component D-7

Dimeric phosphonite, tetrakis(2,4-di-tert-butylphenyl)-1,1-biphenyl-4,4′-diylbisphosphonite, Hostanox™ P-EPQ, Clariant (Muttenz, Switzerland)

### Component D-8

A-C® 907P (Honeywell International Inc., Morristown, USA): Propylene-maleic anhydride copolymer having a saponification number of 90 mg KOH/g and a viscosity at 190° C. of 350 cps.

### Production of the Molding Compounds

### Comparative Example 1

Components A to D-4 were processed into a molding compound in a single compounding step according to the weight fractions shown in table 1 in a Clextral Evolum® 32 HT twin-screw extruder from Clextral SAS (France) at a melt temperature measured in the melt at the die outlet of the extruder of about 315° C. and with application of a negative pressure of 100 mbar (absolute). All components of the composition, with the exception of the talc, were together metered into the inlet of the extruder via the main feed and melted and dispersed in one another by introduction of thermal and mechanical energy. The talc was metered via a side extruder into the melt mixture of the remaining components, i.e. into an extruder zone on the other side of the melting zone relative to the main feed. The residence time of the components in the melt was about 30 seconds during this process.

### Comparative Example 2

Production of the molding compound was carried out in two process steps which were both performed in a Clextral Evolum® 32 HT twin-screw extruder from Clextral SAS (France). In the first process step the total amounts of components A and D-3 according to the weight fractions reported in table 1 were processed into an acid-stabilized polycarbonate precompound at a melt temperature measured in the melt at the die outlet of the extruder of about 315° C. and with application of a negative pressure of 100 mbar (absolute). The residence time of the components in the melt in this first process step was about 30 seconds. In a second process step, the acid-stabilized polycarbonate precompound obtained in step 1 was processed into a molding compound with the other components reported in table 1 in the quantity ratios specified therein in the same twin-screw extruder and under the same temperature, residence time and vacuum conditions. The talc was metered into a melt zone via a side extruder. All other components, including the acid-stabilized polycarbonate precompound, were introduced into the extruder together via the main feed, melted and dispersed in one another before the talc was supplied via the side extruder.

### Inventive Example 3

Production of the molding compound was carried out in two process steps. In a first process step the components B-1, B-2, B-3 and C were mixed with one another in an MX58 co-kneader from Buss AG (Switzerland) in the weight fractions reported in table 1, namely at a temperature, measured in the melt with a thermocouple positioned at the end of the extruder just upstream of the die plate, of about 230° C. Under these conditions the thermoplastic components B-1 and B-3 are in the form of a melt, i.e. the components B-2 and C are dispersed in the melt mixture of components B-1 and B3 in this process step, wherein a molten thermoplastic composition consisting of the intimately mixed components B-1, B-2, B-3 and C is formed in the kneader. The residence time of this molten composition in the kneader in this process step was about 3 minutes. This process step was performed under atmospheric pressure, i.e. without application of a degassing vacuum. The first process step affords a talc masterbatch. In a second process step the talc masterbatch obtained in step 1 was processed into a molding compound with the other constituents reported in table 1 in a Clextral Evolum® 32 HT twin-screw extruder from Clextral SAS (France) at a melt temperature measured in the melt at the die outlet of the extruder of about 315° C. and with application of a negative pressure of 100 mbar (absolute). The residence time of the components in the melt in this second process step was about 30 seconds. All components of the composition, including the talc masterbatch produced in the preceding process step, were together metered into the inlet of the extruder via the main feed and melted and subsequently dispersed in one another in the extruder by introduction of thermal and mechanical energy.

### Comparative Example 4

Similarly to comparative example 1 production was carried out in a single compounding step in a Clextral Evolum® 32 HT twin-screw extruder from Clextral SAS (France). Component B-4 was employed instead of component B-3.

### Inventive Example 5

Similarly to the inventive example 3 production was carried out in two process steps, wherein in turn the first process step was performed in an MX58 co-kneader from Buss AG (Switzerland) and the second process step was performed in a Clextral Evolum® 32 HT twin-screw extruder from Clextral SAS (France). Component B-4 was employed instead of component B-3.

### Comparative Example 6

Production of the molding compound was carried out in two process steps which were both performed in a Clextral Evolum® 32 HT twin-screw extruder from Clextral SAS (France). In the first process step the components B-1, B-2, B-4 and C according to the weight fractions reported in table 1 were processed at a melt temperature measured in the melt at the die outlet of the extruder of about 300° C. and with application of a negative pressure of 100 mbar (absolute). Under these conditions the thermoplastic components B-1 and B-4 are in the form of a melt, i.e. the components B-2 and C are in this process step dispersed in the melt mixture of the components B-1 and B4, wherein a molten, thermoplastic composition consisting of the intimately mixed components B-1, B-2, B-4 and C is formed in the extruder. The residence time of the components in the melt in this first process step was about 30 seconds. The first process step affords a talc masterbatch. In a second process step the talc masterbatch obtained in step 1 was in turn processed into a molding compound with the other constituents reported in table 1 in the aforementioned Clextral Evolum® 32 HT twin-screw extruder from Clextral SAS (France) at a melt temperature measured in the melt at the die outlet of the extruder of about 315° C. and with application of a negative pressure of 100 mbar (absolute). The residence time of the components in the melt in this second process step was about 30 seconds. All components of the composition, including the talc masterbatch produced in the preceding process step, were together metered into the inlet of the extruder via the main feed and melted and subsequently dispersed in one another in the extruder by introduction of thermal and mechanical energy.

### Comparative Example 7

Similarly to comparative example 1 production was carried out in a single compounding step in a Clextral Evolum® 32 HT twin-screw extruder from Clextral SAS (France). The constituents reported for comparative example 7 in table 1 were employed. The temperature of the melt at the die outlet of the extruder was about 305° C.

### Inventive Example 8

Similarly to the inventive example 3 production was carried out in two process steps, wherein in turn the first process step was performed in an MX58 co-kneader from Buss AG (Switzerland) and the second process step was performed in a Clextral Evolum® 32 HT twin-screw extruder from Clextral SAS (France). The constituents reported for example 8 in table 1 were employed. In the first process step the total amounts of components B-5, C and D-8 were processed into a masterbatch. In the second process step this masterbatch was mixed with the remaining components and compounded. In the first process step the melt temperature at the die outlet of the compounding apparatus was about 260° C. and in the second process step said temperature was about 305° C.

### Determination of the Content of Free Bisphenol a in the Compounded Product

To determine the content of free bisphenol A ([BPA] for short) the samples of the produced pellet materials were dissolved in dichloromethane and reprecipitated with acetone. The precipitated compound fraction was separated by filtration and the filtrate was analyzed by high-pressure liquid chromatography with a UV detector (HPLC-UV) using an external standard. A C18 phase was used as the column material and water and methanol in a gradient were used as eluent.

### Production of Shaped Articles and Testing

To determine material ductility under multiaxial stress a puncture test according to ISO 6603-2 (2002 version) was performed at 23° C. on in each case ten test specimens having dimensions of 60 mm×5 60 mm×2 mm for examples V4, 5 and V6. The maximum force and total energy were measured. The percentage proportion of brittle fractures serves as a measure of the material ductility under multiaxial stress. A brittle fracture is to be understood as meaning a fracture failure in which parts of the test specimen shatter out during the puncture test.

The test specimens for the puncture tests were produced at a melt temperature of 260° C. and at a mold temperature of 80° C. in an Arburg 270 E injection molding machine with an injection speed of 40 mm/s.

TABLE 1
Composition of the produced molding compounds and their properties

| Components [% by weight] | V1 | V2 | 3 | V4 | 5 | V6 | V7 | 8 |
|---|---|---|---|---|---|---|---|---|
| A-1 | 48.79 | 48.79 | 48.79 | 48.79 | 48.79 | 48.79 | | |
| A-2 | | | | | | | 57.56 | 57.56 |
| B-1 | 7.97 | 7.97 | 7.97 | 7.97 | 7.97 | 7.97 | | |
| B-2 | 5.98 | 5.98 | 5.98 | 5.98 | 5.98 | 5.98 | | |
| B-3 | 15.94 | 15.94 | 15.94 | | | | | |
| B-4 | | | | 15.94 | 15.94 | 15.94 | | |
| B-5 | | | | | | | 25.47 | 25.47 |
| C | 19.92 | 19.92 | 19.92 | 19.92 | 19.92 | 19.92 | 15.00 | 15.00 |
| D-1 | 0.70 | 0.70 | 0.70 | 0.70 | 0.70 | 0.70 | 0.60 | 0.60 |
| D-2 | 0.10 | 0.10 | 0.10 | 0.10 | 0.10 | 0.10 | | |
| D-3 | 0.20 | 0.20 | 0.20 | 0.20 | 0.20 | 0.20 | | |
| D-4 | 0.40 | 0.40 | 0.40 | 0.40 | 0.40 | 0.40 | | |
| D-5 | | | | | | | 0.03 | 0.03 |
| D-6 | | | | | | | 0.20 | 0.20 |
| D-7 | | | | | | | 0.10 | 0.10 |
| D-8 | | | | | | | 1.04 | 1.04 |
| Mass fraction of free bisphenol | 121 | 148 | 5 | 131 | 27 | 123 | 26 | 8 |
| A in pellet material [ppm] | | | | | | | | |
| Puncture test: maximum force | | | | 3315 | 3861 | 3759 | | |
| [N] | | | | | | | | |
| Puncture test: Total energy [J] | | | | 18 | 24 | 22 | | |
| Puncture test: Percentage | | | | 20 | 0 | 40 | | |
| proportion of brittle fractures | | | | | | | | |
| [%] | | | | | | | | |

The data in Table 1 show that example 3 produced in the inventive process exhibits a markedly lower content of free bisphenol A in the pellet material than comparative examples V1 and V2 produced by other processes. Both in the cases in which all components are mixed in a single step (V1) and in an alternative two-step compounding process, in which an acid-stabilized polycarbonate precompound is initially produced from components A and D-3 in a twin-screw extruder (V2), a disadvantageously high level of free bisphenol A is obtained.

Comparative example 4 again shows that a high content of free bisphenol A is obtained by a process comprising only one compounding step. It is apparent from inventive example 5 and comparative example 6 that a low content of free bisphenol A is achieved only with the inventive process. If the first process step is performed in a twin-screw extruder the content of free bisphenol A is many times higher.

Information regarding the material ductility of the molding compounds is further disclosed for examples V4, 5 and V6. The inventive molding compound from example 5 exhibits a higher maximum strength and a higher total energy in the puncture test than comparative examples V4 and V6. In particular, and in contrast to V4 and V6, no brittle fracture (shatter fracture failure) occurs in the case of example 5.

Comparative example V7 and inventive example 8 show that a reduction in the content of free bisphenol A is also achieved when a polyester is employed as component B in the process according to the invention.

1. A thermoplastic molding compound containing
A) at least one polycarbonate and/or polyester carbonate in each case containing structural units derived from bisphenol A,
B) a further polymer distinct from component A or a mixture consisting of polymers in each case distinct from component A,
wherein component B consists of
B1) at least one thermoplastic polymer and
optionally
B2) at least one non-thermoplastic polymer,
C) at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and combinations of the recited fillers and
D) optionally at least one non-polymeric polymer additive and/or at least one non-polymeric process auxiliary in each case distinct from component C,
wherein the weight ratio of component B to component C is at least 0.5
and wherein the weight fraction of component B1 in component B is at least 20%
and wherein the molding compound has a mass fraction of free bisphenol A of less than 30 ppm.

2. The molding compound as claimed in claim 1, containing
30% to 85% by weight of component A,
2% to 50% by weight of component B,
3% to 40% by weight of component C,
0% to 10% by weight of component D.

3. The molding compound as claimed in claim 1, wherein the weight ratio of component B to component C is 0.5 to 5.

4. The molding compound as claimed in claim 1, wherein component C contains talc.

5. The molding compound as claimed in claim 1, wherein component B is selected from the group consisting of rubber-free vinyl (co)polymers, rubber-modified vinyl (co)polymers, aromatic polyesters and mixtures thereof.

6. The molding compound as claimed in claim 1, wherein component A contains at least 20% by weight, based on the sum of all structural units derived from bisphenols, of structural units derived from bisphenol A.

7. A process for producing a thermoplastic molding compound comprising the steps of
(i) producing a masterbatch by melt compounding the following components in an internal kneader or a co-kneader:
B) a polymer distinct from polycarbonate containing structural units derived from bisphenol A and distinct from polyester carbonate containing structural units derived from bisphenol A or a mixture consisting of polymers distinct from polycarbonate containing structural units derived from bisphenol A and distinct from polyester carbonate containing structural units derived from bisphenol A,
wherein component B consists of
B1) at least one thermoplastic polymer and
optionally
B2) at least one non-thermoplastic polymer,
C) at least one inorganic filler selected from the group consisting of quartz compounds, talc, wollastonite, kaolin, CaCO₃, titanium dioxide and titanium dioxide in combination with other inorganic pigments, Al(OH)₃, AlO(OH), Mg(OH)₂ and mica and combinations of the recited fillers and
D) optionally a non-polymeric polymer additive and/or at least one non-polymeric
process auxiliary, in each case distinct from component C,
wherein the weight ratio of component B to component C is at least 0.5, and
wherein the weight fraction of component B1 in component B is at least 50%,
(ii) melt compounding the masterbatch obtained in step (i) with at least one polycarbonate and/or polyester carbonate in each case containing structural units derived from bisphenol A as component A and optionally further proportions of components B, C and/or D and/or the total amount of component D.

8. The process as claimed in claim 7, wherein component C contains talc.

9. The process as claimed in claim 7, wherein component B is selected from the group consisting of rubber-free vinyl (co)polymers, rubber-modified vinyl (co)polymers, aromatic polyesters and mixtures thereof.

10. The process as claimed in claim 7, wherein step (ii) is performed in a compounding apparatus selected from the group consisting of single-shaft extruders, co-rotating or counter-rotating twin-screw extruders, planetary roller extruders, internal kneaders and co-kneaders.

11. The process as claimed in claim 7, wherein step (i) is performed in a co-kneader.

12. The process as claimed in claim 7, wherein step (ii) is performed in a twin-screw extruder.

13. The process as claimed in claim 7, wherein step (i) is performed in a co-kneader at a temperature of the melt in the range from 210° C. to 260° C. and step (ii) is performed in a twin-screw extruder at a temperature of the melt in the range from 260° C. to 320° C.

14. The process as claimed in claim 7, wherein step (i) is performed in a co-kneader with a residence time of the components in the melt in the range from 1 to 5 minutes and step (ii) is performed in a twin-screw extruder at a residence time of the components in the melt in the range from 15 to 60 seconds.

15. A shaped article containing a molding compound as claimed in claim 1.
